(19) United States
(12) Patent Application Publication
(10) Pub. No.: US 2013/0181921 A1
(43) Pub. Date: Jul. 18, 2013

(54) TOUCH PANEL AND DISPLAY DEVICE EQUIPPED WITH TOUCH PANEL

(71) Applicant: Japan Display East Inc., Mobara-shi (JP)

(72) Inventors: Yuka KUWAJIMA, Chofu (JP); Shinji TANABE, Mobara (JP); Sakae ISHII, Mobara (JP)

(73) Assignee: JAPAN DISPLAY EAST INC., Mobara-shi (JP)

(21) Appl. No.: 13/733,921

(22) Filed: Jan. 4, 2013

(30) Foreign Application Priority Data
Jan. 13, 2012 (JP) 2012-004850

(51) Int. Cl. G06F 3/041

(52) U.S. Cl. CPC G06F 3/041
USPC 345/173

(57) ABSTRACT

A touch panel includes a transparent electrode for sensing and a metal mark that overlaps with the transparent electrode in a sensing enable area, and a metal line that extends along a contour of the sensing enable area in a peripheral area. The transparent electrode is electrically connected to the metal line. A light shielding area of a cover substrate includes a first portion that overlaps with the peripheral area, and a second portion that partially overlaps with the sensing enable area so as to cover the transparent electrode and the metal mark.

### CROSS-REFERENCE TO RELATED APPLICATION

The present application claims priority from Japanese application JP2012-004850 filed on Jan. 13, 2012, the content of which is hereby incorporated by reference into this application.

### BACKGROUND OF THE INVENTION

1. Field of the Invention

The present invention relates to a touch panel and a display device having the touch panel.

2. Description of the Related Art

There has been known a liquid crystal display device having a transparent substrate called “front window” on a liquid crystal display panel (JP 2010-78898 A). An opaque area (print section) is present in a peripheral area of the front window, and the peripheral area of a display area of the liquid crystal display panel is hidden by the print section.

In a liquid crystal display device (JP 2008-83491 A) having a touch panel as an interface, the front window is put on the touch panel. The touch panel and the front window are positioned on the basis of the respective contours thereof.

The peripheral area (area outside of an effective area where an input is conducted) of the touch panel is also narrowed according to the narrowed peripheral area of the liquid crystal display panel. For that reason, when the print section formed in the front window is positionally displaced, there arises such a problem that a metal line present in the peripheral area of the touch panel is observable from an opening area surrounded by the print section of the front window.

### SUMMARY OF THE INVENTION

An object of the present invention is to provide a display device that can precisely position a touch panel and a cover substrate having a light transmission area.

(1) According to the present invention, there is provided a display device including: a display panel having a display area; a touch panel having a sensing enable area overlapping with the display area, and a peripheral area outside of the sensing enable area; and a cover substrate including a light transmission area overlapping with the display area and the sensing enable area, and a light shielding area surrounding the light transmission area, in which the touch panel has a transparent electrode and a metal layer that overlaps with the transparent electrode in the sensing enable area, and has a metal line in the peripheral area, and the transparent electrode is electrically connected to the metal line, and in which the light shielding area of the cover substrate covers the metal line of the touch panel and the metal layer formed in the sensing enable area. According to the present invention, because the metal layer overlaps with the transparent electrode, the metal layer can be used as a positioning mark.

(2) In the display device according to the item (1), the light shielding area of the cover substrate includes a first portion that overlaps with the peripheral area so as to cover the metal line of the touch panel, and a second portion that overlaps with a part of the sensing enable area so as to cover the transparent electrode and the metal layer, an edge of the first portion adjacent to the light transmission area is located adjacent to the metal line, and an edge of the second portion adjacent to the light transmission area is located adjacent to the metal layer. With this configuration, the first portion is positioned with the metal line as an alignment mark, and the second portion is positioned with the metal layer as the alignment mark so that the light shielding area of the cover substrate and the touch panel can be positioned. In particular, since the edge of the second portion in the light shielding area is located inside of the transparent electrode, the metal line cannot serve as the alignment mark, but the metal layer can be used as the alignment mark.

(3) In the display device according to the item (2), the light transmission area is square, the first portion of the light shielding area is adjacent to three sides of the light transmission area, and the second portion of the light shielding area is adjacent to a remaining side of the light transmission area except for the three sides.

(4) In the display device according to the item (2) or (3), the light shielding area is formed into a frame shape having an opening, the opening is displaced from a center of a contour of the light shielding area toward any direction, and the second portion is adjacent to the opening on a side opposite to the direction toward which the opening is displaced.

(5) In the display device according to any one of the items (1) to (4), the cover substrate is made of a light transmission material, and a light shielding film is formed in the light shielding area.

(6) In the display device according to any one of the items (2) to (4), the cover substrate has a mark indicative of a touch button in the second portion of the light shielding area so as to overlap with the transparent electrode.

(7) In the display device according to any one of the items (1) to (6), the transparent electrode includes a first electrode extending in a first direction, and a second electrode extending in a second direction orthogonal to the first direction, the first electrode includes a plurality of first pad parts which are aligned in the first direction, and first connection parts that are thinner than the respective first pad parts, and connect the adjacent first pad parts in the first direction, the second electrode includes a plurality of second pad parts which are aligned in the second direction, and second connection parts that are thinner than the respective second pad parts, and connect the adjacent second pad parts in the second direction, and the metal layer overlaps with the second pad parts so as to prevent from overlapping with the first electrode and the second connection parts.

(8) In the display device according to the item (7), the first pad parts, the second pad parts, and the second connection parts are formed in the same layer position, the first pad parts and the first connection parts are formed in different layer positions and electrically connected to each other, and the first connection parts and the second connection parts sterically intersect with each other through an insulating film.

(9) In the display device according to the item (7) or (8) , the second pad parts are larger in area than the first pad parts.

(10) In the display device according to the item (9), the second pad parts each have a width in the first direction larger than a width in the second direction, and the metal layer extends to be longer in the first direction.

(11) According to the present invention, there is provided a touch panel including: a cover substrate having a light transmission area and a light shielding area surrounding the light transmission area, in which the touch panel has a sensing enable area and a peripheral area surrounding the sensing enable area, a transparent electrode and a metal layer are formed in the sensing enable area, the transparent electrode includes a first electrode extending in a first direction and a second electrode extending in a second direction intersecting with the first direction, the metal layer overlaps with the transparent electrode, a metal line which is connected to the transparent electrode is formed in the peripheral area, and the cover substrate has the light transmission area arranged opposite to the sensing enable area of the touch panel, and the light shielding area arranged opposite to the peripheral area and the metal layer formed in the sensing enable area.

### BRIEF DESCRIPTION OF THE DRAWINGS

FIG. 1 is a perspective view illustrating a display device according to an embodiment of the present invention;

FIG. 2 is a cross-sectional view illustrating the display device according to the embodiment of the present invention;

FIG. 3 is a plan view of a touch panel;

FIG. 4 is a partially enlarged view of the touch panel illustrated in FIG. 3;

FIG. 5 is a cross-sectional view of the touch panel illustrated in FIG. 4, taken along a line V-V;

FIG. 6 is a cross-sectional view of the touch panel illustrated in FIG. 4, taken along a line VI-VI;

FIG. 7 is a diagram illustrating a laminated structure of a lower transparent conductive film and a metal film;

FIG. 8 is a diagram illustrating the metal film;

FIG. 9 is a diagram illustrating a laminated structure of the lower transparent conductive film, the metal film, and an insulating film;

FIG. 10 is a diagram illustrating an upper transparent conductive film; and

FIG. 11 is a cross-sectional view illustrating a display device according to an embodiment of the present invention.

### DETAILED DESCRIPTION OF THE INVENTION

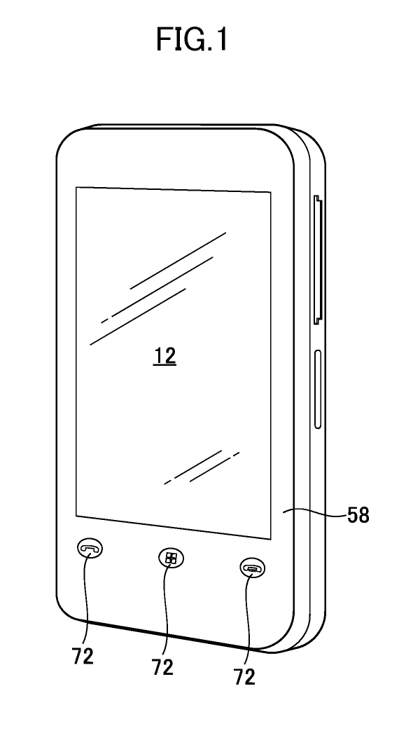

FIG. 1 is a perspective view illustrating an equipment having a display device according to an embodiment of the present invention. The equipment illustrated in FIG. 1 shows an example in which the display device of the present invention is applied to a smart phone, which includes a touch panel interface.

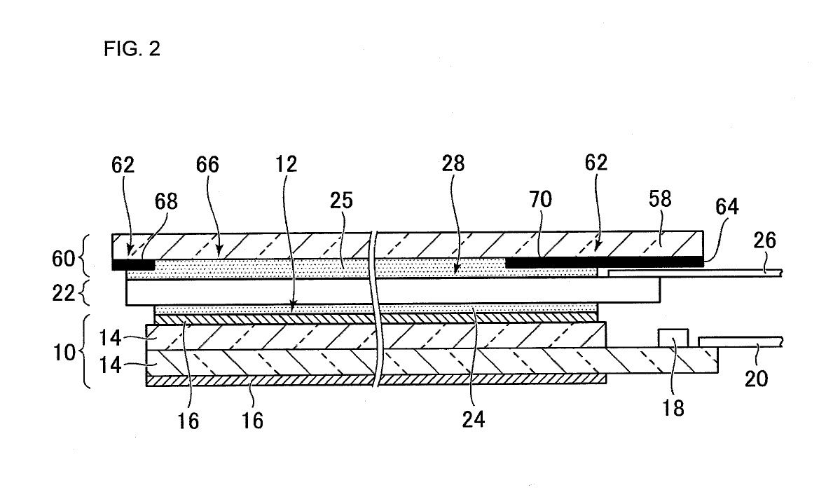

FIG. 2 is a cross-sectional view illustrating the display device having a touch panel according to the embodiment of the present invention. The display device has a display panel 10. The display panel 10 includes a display area 12. In this embodiment, the display panel 10 is configured by a liquid crystal display panel having a pair of substrates 14 (glass substrates), and liquid crystal not shown interposed between those substrates 14. A driving system of the liquid crystal may be any of an IPS (in plane switching) system, a TN (twisted nematic) system, and a VA (vertical alignment) system, and electrodes and lines are formed according to the system. A polarization plate 16 is stuck on each of the substrates 14. An integrated circuit chip 18 having a driver circuit for driving the liquid crystal therein is mounted on and a flexible wiring substrate 20 is fitted to a peripheral portion of one substrate 14. Alternatively, the display panel 10 may be configured by an organic EL (electro luminescence).

The display device includes a touch panel 22 (for example, touch panel of a capacitive coupling system) . A rectangular touch panel 22 is arranged to overlap with the rectangular display panel 10. The touch panel 22 and the display panel 10 are bonded together by an adhesive layer 24. Since the touch panel 22 is arranged on the display area 12 of the display panel 10, an entry can be conducted on an image of the display panel 10 by fingers. The touch panel 22 is electrically connected with a flexible wiring board 26. Also, for example, a sensing area of the touch panel 22 is formed to be larger than the display area 12 of the display device, and a contour of a cover substrate 58 is formed to be larger than a contour of the touch panel 22.

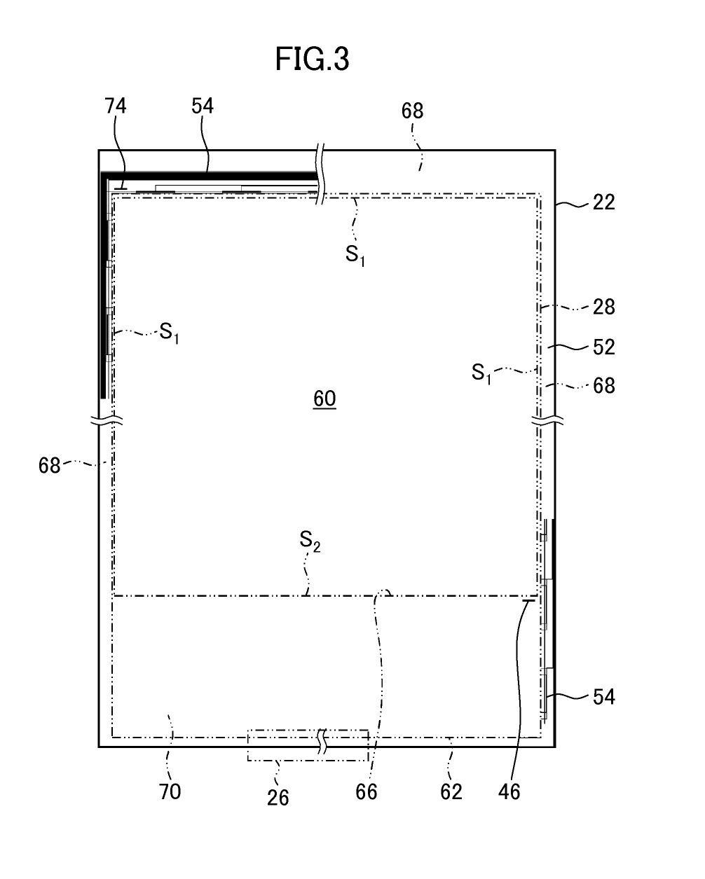

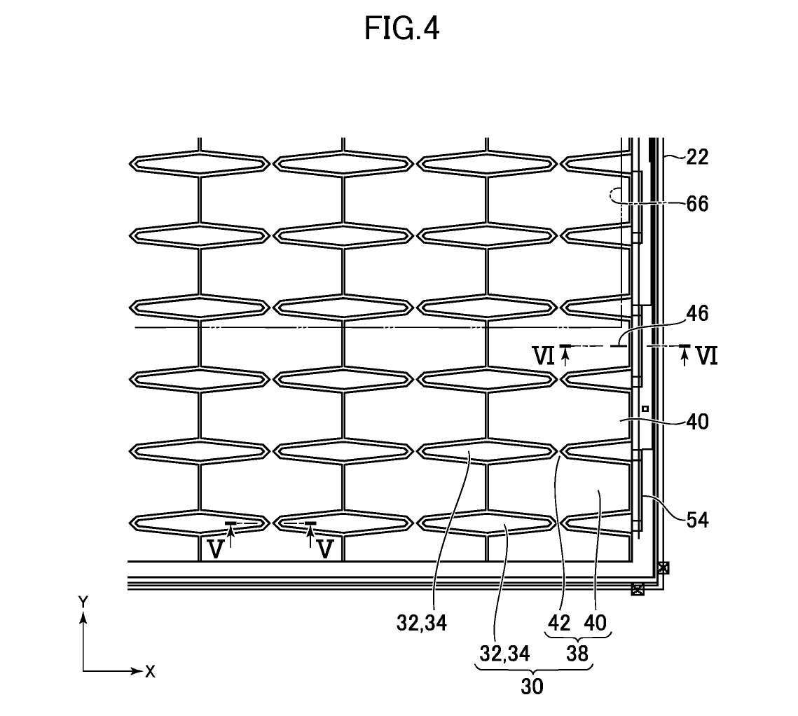

FIG. 3 is a schematic diagram of the display device viewed from the cover substrate (cover glass) 58. Also, a part of the schematic diagram illustrates wiring of the touch panel 22 by cutting off a peripheral portion of the cover substrate 58. FIG. 4 is a partially enlarged view of the touch panel 22. FIG. 5 is a cross-sectional view of the touch panel 22 illustrated in FIG. 4, taken along a line V-V. The touch panel 22 includes a sensing enable area 28, and a peripheral area 52 surrounding the sensing enable area 28 (refer to FIG. 3). The sensing enable area 28 of the touch panel 22 is arranged to face the display area 12 of the display panel 10. Referring to FIG. 3, an inside of an outer two-dot chain line indicates the sensing enable area 28. As illustrated in FIG. 4, a plurality of transparent electrodes 30 for sensing, and a metal layer 46 are formed in the sensing enable area 28. Each of the transparent electrodes 30 includes a first electrode 32 extending in a first direction, and a second electrode 38 extending in a second direction.

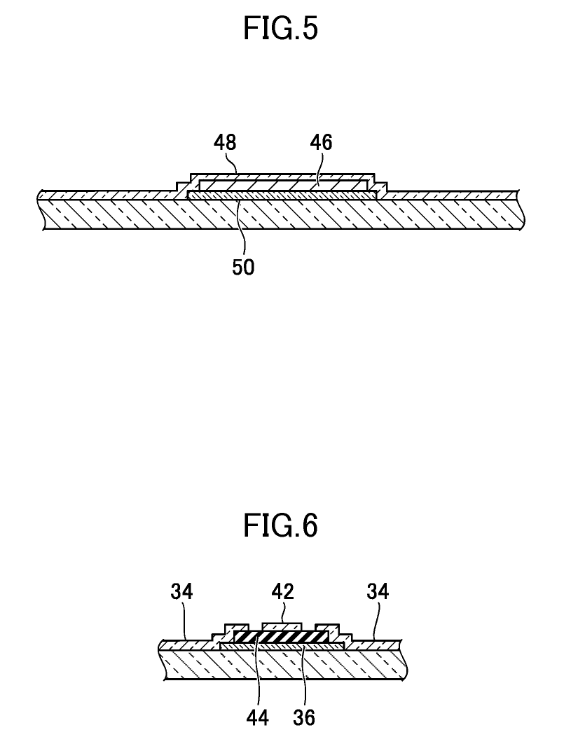

Each of the plurality of transparent electrodes 30 includes the first electrode 32 extending in a first direction X (horizontal direction in FIG. 4). The first electrode 32 includes a plurality of first pad parts 34 which are aligned in the first direction X. The first electrode 32 includes first connection parts 36 that each connect the adjacent first pad parts 34 to each other in the first direction X (refer to FIG. 6). The first pad parts 34 and the first connection parts 36 are formed in different layer positions, and electrically connected to each other. The first connection parts 36 are formed to be thinner than the first pad parts 34 to be connected.

Each of the plurality of transparent electrodes 30 includes the second electrode 38 extending in a second direction Y (vertical direction in FIG. 4) orthogonal to the first direction X. The second electrode 38 includes a plurality of second pad parts 40 which are aligned in the second direction Y. The second pad parts 40 are larger in area than the first pad parts 34. The second pad parts 40 have a width in the first direction X (horizontal direction in FIG. 4) larger than a width in the second direction Y (vertical direction in FIG. 4). The second electrode 38 includes second connection parts 42 that each connect the adjacent second pad parts 40 to each other in the second direction Y. The second connection parts 42 are formed to be thinner than the second pad parts 40 to be connected.

The first pad parts 34, the second pad parts 40, and the second connection parts 42 are formed in the same layer position. As illustrated in FIG. 6, the first connection parts 36 and the second connection parts 42 sterically intersect with each other through an insulating film 44.

As illustrated in FIG. 4, the metal layer 46 that overlaps with any transparent electrodes 30 is formed in the sensing enable area 28 illustrated in FIG. 3. In detail, the metal layer 46 is arranged to overlap with the second pad parts 40 while preventing from overlapping with the first electrode 32 and the second connection parts 42. The metal layer 46 extends to be longer in the first direction X. The metal layer 46 is used to position the touch panel 22. Hereinafter, the metal layer 46 is called “metal mark”.

The second pad parts 40 extend to be longer in the first direction X than in the second direction Y, and the metal mark 46 extends in the longer direction. For that reason, since the metal mark 46 can be separated from a pair of the first pad parts 34 located on both sides of the second pad parts 40, the formation of a bypass capacitor can be avoided. Also, the width of the second pad parts 40 in the second direction Y is wider than the width of the first pad parts 34 in the second direction Y. Accordingly, the formation of the bypass capacitor can be surely avoided when the metal mark 46 overlaps with the second pad parts 40 as illustrated in FIG. 4, more than when the metal mark 46 overlaps with the first pad parts 34.

FIG. 5 is a cross-sectional view of the touch panel 22 illustrated in FIG. 4, taken along a line V-V. The metal mark 46 overlaps with the transparent electrodes 30, and is formed between an upper transparent conductive film 48 and a lower transparent conductive film 50 which are made of ITO (Indium Tin Oxide). The upper transparent conductive film 48 represents a film forming the first pad parts 34, the second pad parts 40, and the second connection parts 42 illustrated in FIG. 4. The lower transparent conductive film 50 represents a film forming the first connection parts 36 illustrated in FIG. 6, but also remains under the metal mark 46 through a manufacturing process.

As illustrated in FIG. 3, the touch panel 22 has the peripheral area 52 outside of the sensing enable area 28. The touch panel 22 has a plurality of metal lines 54 extending along a contour of the sensing enable area 28 in the peripheral area 52. The above-mentioned transparent electrodes 30 are electrically connected to any metal lines 54.

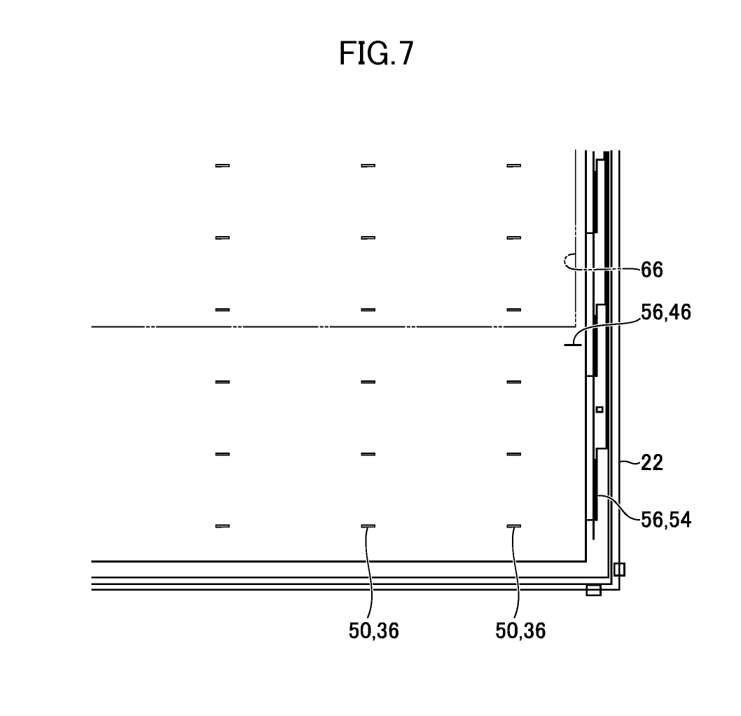

FIGS. 7 to 10 are diagrams illustrating a laminated structure of the touch panel 22. In the touch panel 22, the lower transparent conductive film 50, a metal film 56, the insulating film 44, and the upper transparent conductive film 48 are laminated in the stated order from the bottom.

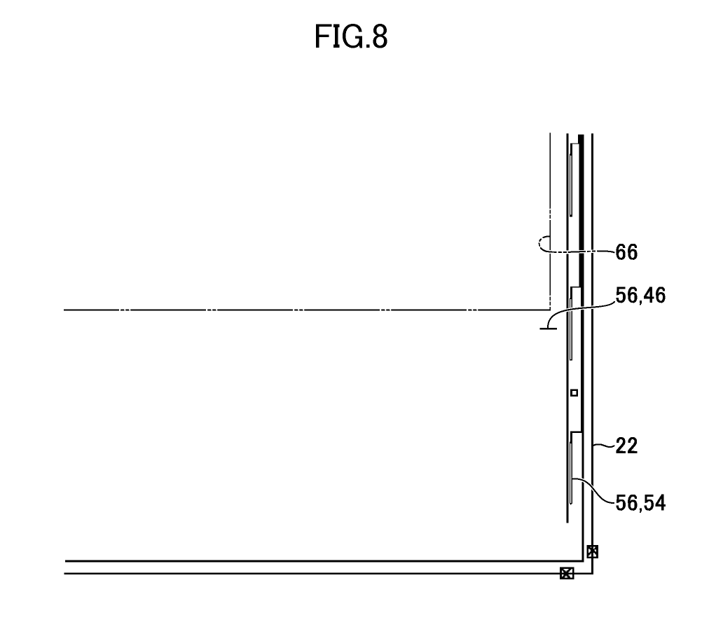

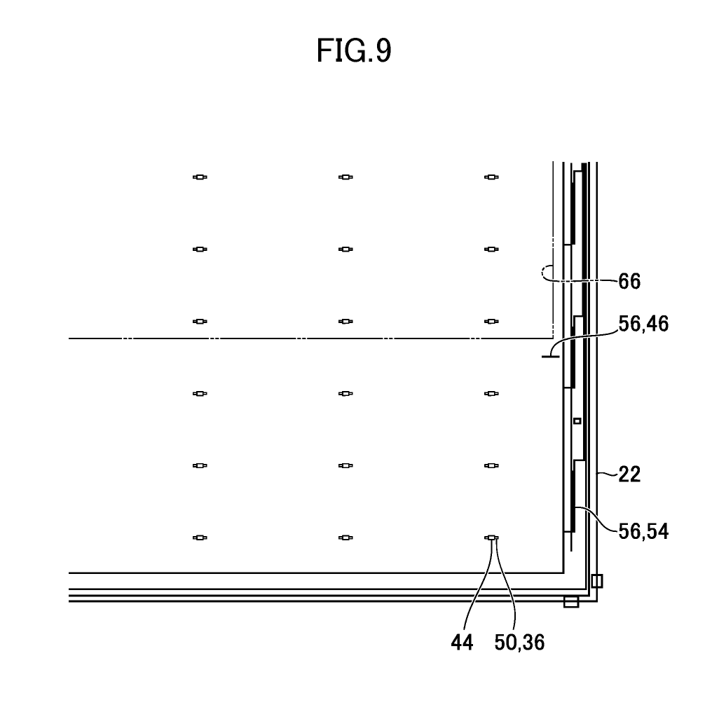

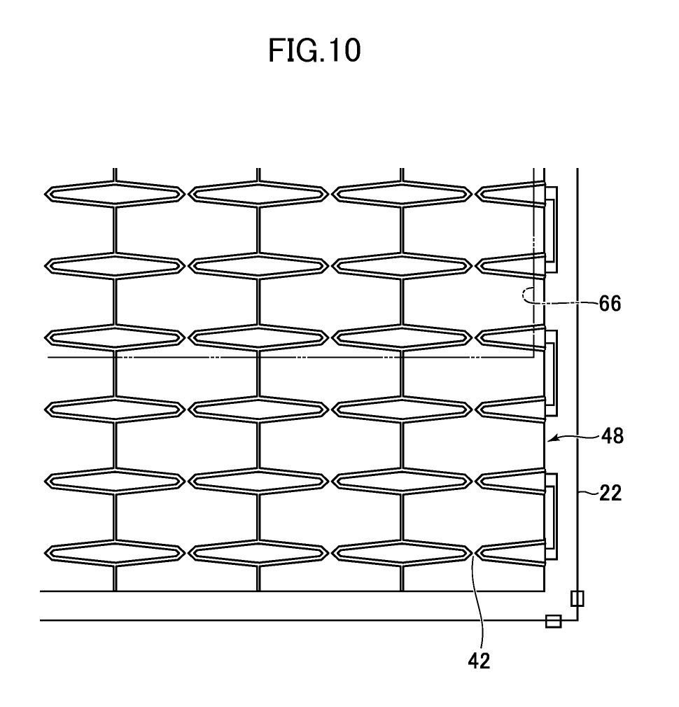

FIG. 7 is a diagram illustrating a laminated structure of the lower transparent conductive film 50 and the metal film 56. FIG. 8 is a diagram illustrating the metal film 56. As illustrated in FIG. 7, the lower transparent conductive film 50 forms the first connection parts 36. As illustrated in FIG. 8, the metal film 56 is arranged above the lower transparent conductive film 50 except for the first connection parts 36, and forms the metal mark 46 and the metal lines 54. First, the lower transparent conductive film 50 (first connection parts 36) is formed, and the metal film 56 (metal mark 46 and metal lines 54) is then formed. The metal mark 46 and the metal lines 54 are formed in a lump, and therefore of the same layer. FIG. 9 is a diagram illustrating a laminated structure of the lower transparent conductive film 50, the metal film 56, and the insulating film 44. As illustrated in FIG. 9, the insulating film 44 is arranged on the first connection parts 36. The insulating film 44 is formed after the metal film 56 has been formed. FIG. 10 is a diagram illustrating the upper transparent conductive film 48. The upper transparent conductive film 48 illustrated in FIG. 10 is formed on the structure illustrated in FIG. 9. The second connection parts 42 are not rendered conductive with the first connection parts 36 by the insulating film 44.

As illustrated in FIGS. 1 and 2, the display device has the cover substrate 58. The cover substrate 58 is made of a light transmission material (for example, glass). The cover substrate 58 has a light transmission area 60 that overlaps with the display area 12 and the sensing enable area 28. The light transmission area 60 is square (refer to FIG. 3).

As indicated by a two-dot chain line in FIG. 3, the cover substrate 58 has a light shielding area 62 (area surrounded by an inner two-dot chain line) that shields a light so as to surround the light transmission area 60. The light shielding area 62 is formed with a light shielding film 64 (print layer), for example, by printing. As illustrated in FIG. 3, the light shielding area 62 is formed into a frame shape having an opening 66. The opening 66 is displaced from a center of a contour (or contour of the cover substrate 58) of the light shielding area 62 toward any direction. In the cover substrate 58, the light transmission area 60 is arranged opposite to the sensing enable area 28 of the touch panel 22, and the light shielding area 62 is arranged opposite to the peripheral area 52, a part of the sensing enable area 28, and the metal mark 46 formed in the sensing enable area 28.

As illustrated in FIG. 3, the light shielding area 62 of the cover substrate 58 has a first portion 68 that overlaps with the peripheral area 52 so as to cover the plurality of metal lines 54. The first portion 68 of the light shielding area 62 is adjacent to three sides S₁ of the light transmission area 60. An edge of the first portion 68 adjacent to the light transmission area 60 is located adjacent to any metal lines 54. FIG. 3 illustrates only apart of the metal lines 54, and the other metal lines 54 are omitted from the drawing.

The light shielding area 62 of the cover substrate 58 includes a second portion 70 that overlaps with a part of the sensing enable area 28 so as to cover any transparent electrodes 30 and the metal mark 46. An edge of the second portion 70 adjacent to the light transmission area 60 is located adjacent to the metal mark 46. The second portion 70 of the light shielding area 62 is adjacent to one remaining side S₂ except for the three sides S₁ of the light transmission are 60. The second portion 70 is adjacent to the opening 66 on a side opposite to the direction along which the opening 66 is displaced from the center of the contour of the light shielding area 62.

The cover substrate 58 has a mark 72 indicative of a touch button in the second portion 70 of the light shielding area 62 so as to overlap with any transparent electrode 30 as illustrated in FIG. 1. The mark 72 is deviated from the display area 12, and when a user touches the mark 72, sensing is conducted in the sensing enable area 28 to conduct given operation.

According to this embodiment, the first portion 68 is positioned with the metal lines 54 as an alignment mark, and the second portion 70 is positioned with the metal mark 46 as an alignment mark, to thereby position the light shielding area 62 of the cover substrate 58 and the touch panel 22. The positioning is conducted by recognizing the metal lines 54 and the metal mark 46 on the light shielding film 64 while observing from the touch panel 22 side.

Since the edge of the second portion 70 in the light shielding area 62 is located inside of the transparent electrodes 30, the metal lines 54 cannot serve as the alignment mark, but the metal mark 46 can be used as the alignment mark.

In this embodiment, as illustrated in FIG. 3, a second metal mark 74 is provided. The metal mark 46 and the second metal mark 74 are point-symmetrical with respect to a center of the opening 66. The second metal mark 74 is arranged in the peripheral area 52 (outside of the sensing enable area 28). The second metal mark 74 can be used as a positioning mark of the light shielding area 62 instead of the metal lines 54.

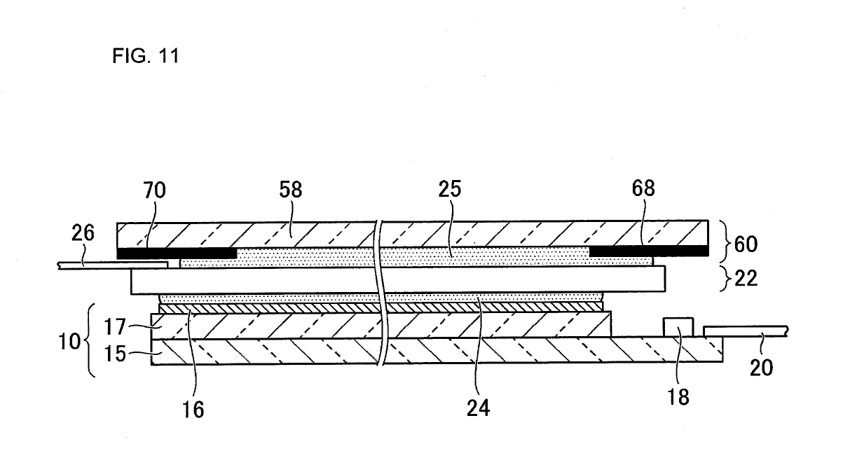

FIG. 11 illustrates an example in which the flexible wiring substrate 20 connected to the display panel 10 and the flexible wiring board 26 connected to the touch panel 22 are drawn in different directions. Also, a display device of FIG. 11 uses an organic EL. The flexible wiring substrate 20 connected to the display panel 10 is connected to a circuit board 15 of the organic EL display device. A sealing substrate 17 is arranged on a surface of the circuit board 15 on which circuits are formed, and prevents moisture from entering the circuits. The display device in FIG. 11 represents a top emission organic EL display device, and the polarization plate 16 is arranged on a display side of the display device for the purpose of suppressing reflection of an outside light. The touch panel 22 is bonded on the polarization plate 16 by the adhesive layer 24.

When the display device is viewed from an observer side, the flexible wiring board 26 connected to the touch panel 22 is connected to the touch panel 22 on a side opposite to a side on which the flexible wiring substrate 20 is connected to the display panel 10. With this configuration, a contact of the flexible wiring board 26 connected to the touch panel 22 and the flexible wiring substrate 20 connected to the display panel 10 can be suppressed. When the flexible wiring board 26 connected to the touch panel 22 and the flexible wiring substrate 20 connected to the display panel 10 are connected to the same circuit board, the flexible wiring substrate 20 and the flexible wiring board 26 may be arranged on the same side as illustrated in FIG. 2.

Even in the above case, the metal mark 46 formed of the metal layer overlaps with the transparent electrodes 30, and the metal mark 46 can be confirmed from an upper surface or a lower surface of the touch panel 22. This facilitates the positioning of the touch panel.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a display panel having a display area;
a touch panel having a sensing enable area overlapping with the display area, and a peripheral area outside of the sensing enable area; and
a cover substrate including a light transmission area overlapping with the display area and the sensing enable area, and a light shielding area surrounding the light transmission area,
wherein the touch panel has a transparent electrode and a metal layer that overlaps with the transparent electrode in the sensing enable area, and has a metal line in the peripheral area, and the transparent electrode is electrically connected to the metal line, and
wherein the light shielding area of the cover substrate covers the metal line of the touch panel and the metal layer formed in the sensing enable area.

2. The display device according to claim 1,
wherein the light shielding area of the cover substrate includes a first portion that overlaps with the peripheral area so as to cover the metal line of the touch panel, and a second portion that overlaps with a part of the sensing enable area so as to cover the transparent electrode and the metal layer, an edge of the first portion adjacent to the light transmission area is located adjacent to the metal line, and an edge of the second portion adjacent to the light transmission area is located adjacent to the metal layer.

3. The display device according to claim 2,
wherein the light transmission area is square,
wherein the first portion of the light shielding area is adjacent to three sides of the light transmission area, and
wherein the second portion of the light shielding area is adjacent to a remaining side of the light transmission area except for the three sides.

4. The display device according to claim 2,
wherein the light shielding area is formed into a frame shape having an opening,
wherein the opening is displaced from a center of a contour of the light shielding area toward any direction, and
wherein the second portion is adjacent to the opening on a side opposite to the direction toward which the opening is displaced.

5. The display device according to claim 1,
wherein the cover substrate is made of a light transmission material, and a light shielding film is formed in the light shielding area.

6. The display device according to claim 2,
wherein the cover substrate has a mark indicative of a touch button in the second portion of the light shielding area so as to overlap with the transparent electrode.

7. The display device according to claim 1,
wherein the transparent electrode includes a first electrode extending in a first direction, and a second electrode extending in a second direction orthogonal to the first direction,
wherein the first electrode includes a plurality of first pad parts which are aligned in the first direction, and first connection parts that are thinner than the respective first pad parts, and connect the adjacent first pad parts in the first direction,
wherein the second electrode includes a plurality of second pad parts which are aligned in the second direction, and second connection parts that are thinner than the respective second pad parts, and connect the adjacent second pad parts in the second direction, and
wherein the metal layer overlaps with the second pad parts so as to prevent from overlapping with the first electrode and the second connection parts.

8. The display device according to claim 7,
wherein the first pad parts, the second pad parts, and the second connection parts are formed in the same layer position,
wherein the first pad parts and the first connection parts are formed in different layer positions and electrically connected to each other, and
wherein the first connection parts and the second connection parts sterically intersect with each other through an insulating film.

9. The display device according to claim 7,
wherein the second pad parts are larger in area than the first pad parts.

10. The display device according to claim 9,
wherein the second pad parts each have a width in the first direction larger than a width in the second direction, and
wherein the metal layer extends to be longer in the first direction.

11. A touch panel comprising:
a cover substrate having a light transmission area and a light shielding area surrounding the light transmission area,
wherein the touch panel has a sensing enable area and a peripheral area surrounding the sensing enable area,
wherein a transparent electrode and a metal layer are formed in the sensing enable area,
wherein the transparent electrode includes a first electrode extending in a first direction and a second electrode extending in a second direction intersecting with the first direction,
wherein the metal layer overlaps with the transparent electrode,
wherein a metal line which is connected to the transparent electrode is formed in the peripheral area, and
wherein the cover substrate has the light transmission area arranged opposite to the sensing enable area of the touch panel, and the light shielding area arranged opposite to the peripheral area and the metal layer formed in the sensing enable area.
